(19) United States
(12) Patent Application Publication
(10) Pub. No.: US 2013/0057925 A1
(43) Pub. Date: Mar. 7, 2013

(54) Real-time electronic facsimile delivery system

(71) Applicants: Vladimir G. Shmunis, Hillsborough, CA (US); Igor Rusinov, San Jose, CA (US); Vlad Vendrow, Redwood City, CA (US)

(72) Inventors: Vladimir G. Shmunis, Hillsborough, CA (US); Igor Rusinov, San Jose, CA (US); Vlad Vendrow, Redwood City, CA (US)

(73) Assignee: Ring Central, Inc.

(21) Appl. No.: 11/973,309

(22) Filed: Oct. 5, 2007

Related U.S. Application Data
(60) Provisional application No. 60/828,452, filed on Oct. 6, 2006.

(51) Int. Cl. H04N 1/00; G06K 15/00

(52) U.S. Cl. 358/402; 358/400; 358/1.15

(57) ABSTRACT

Embodiments of the invention relate generally to computing devices and systems, as well as software, computer programs, applications, and user interfaces, and more particularly, to systems, devices and methods to facilitate real-time facsimile delivery.

### CROSS-REFERENCE TO RELATED APPLICATIONS

This application is a U.S. nonprovisional patent application that claims the benefit of U.S. Provisional Patent Application No. 60/828,452, filed Oct. 6, 2006 with Attorney Docket No. 18166-005P01, and entitled “Message Transmission System,” which is herein incorporated by reference for all purposes.

### FIELD OF THE INVENTION

Embodiments of the invention relate generally to computing devices and systems, as well as software, computer programs, applications, and user interfaces, and more particularly, to systems, devices and methods to facilitate real-time facsimile delivery.

### BACKGROUND

Electronic faxing has increasingly become a viable choice for users to transmit electronic messages using common fax machines. Yet, sending conventional electronic faxes usually requires significant network resources, such as a significant amount of storage, to ensure delivery of various quantities of faxes. In some conventional approaches, electronic faxes are intermediately stored prior to sending to the destination. So, when the destination is unavailable to receive the electronic fax, then electronic faxes are typically saved for later delivery. This and other traditional fax delivery techniques usually increase the need for extra resources, which add to the burden of storage on a network.

In some conventional approaches, a server in a network is designated to terminate electronic fax transmissions during a session. But terminating electronic faxes in the network can require additional resources within the network, thereby increasing the overhead associated with delivering faxes.

Thus, a solution is needed to provide a real-time facsimile delivery system, without the limitations of conventional techniques.

### BRIEF DESCRIPTION OF THE DRAWINGS

The invention and its various embodiments are more fully appreciated in connection with the following detailed description taken in conjunction with the accompanying drawings, in which:

FIG. 1 illustrates an example of an electronic facsimile delivery system, according to at least one embodiment of the invention;

FIG. 2 illustrates an example of a flow chart for a real-time electronic facsimile delivery system, according to at least one embodiment of the invention;

FIG. 3 illustrates an example of a delivery system operating in at least two modes of operation, according to at least one embodiment of the invention;

FIG. 4 illustrates an example of an endpoint-to-endpoint real-time facsimile receiving system, according to at least one embodiment of the invention;

FIG. 5 illustrates an example of an endpoint-to-endpoint real-time facsimile sending system, according to at least one embodiment of the invention;

FIG. 6 illustrates an example of an endpoint-to-server facsimile receiving system, according to at least one embodiment of the invention;

FIG. 7 illustrates an example of an endpoint-to-server facsimile sending system, according to at least one embodiment of the invention; and

FIG. 8 illustrates an exemplary computer system suitable for generating electronic facsimiles, according to at least one embodiment of the invention.

### DETAILED DESCRIPTION

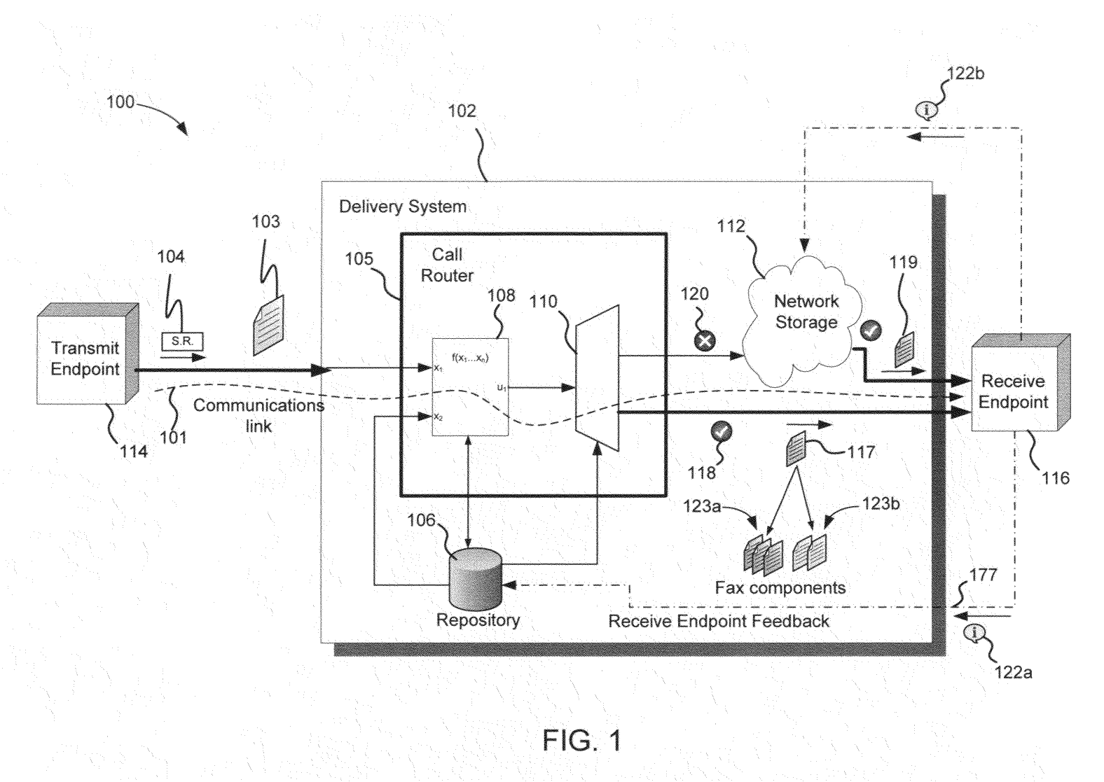

FIG. 1 illustrates an example of an electronic facsimile delivery system, according to at least one embodiment of the invention. Here, diagram 100 shows a delivery system 102, a session request 104 for establishing, for example, a communications link 101, a repository 106, and a call router 105 configured to determine a route over which to transmit electronic facsimile 103. Further, diagram 100 depicts a network storage 112, a transmit endpoint 114, a receive endpoint 116, an online status indicator 118, an offline status indicator 120, and a status notification message 122. As shown, call router 105 can include routing logic 108 and call action logic 110. In some examples, delivery system 102 may be implemented to provide either a direct connection via communication link 101 (i.e., endpoint-to-endpoint, excluding network storage 112) for sending electronic facsimiles or an indirect connection that includes a storage capability for storing the electronic facsimiles in network storage 112, or both. In other examples, delivery system 102 may be implemented to provide faxing only over a direct connection without requiring storage (e.g., without storage such as provided by network storage 112). In some instances, delivery system 102 can be configured to deny storage of the electronic facsimile (or portions thereof) prior to transmission, thereby conserving the storage capacity for a storage device, such as represented by network storage 112. Further, various implementations may include postponing electronic facsimiles when the receiving fax node is not available. Note that while FIG. 1 shows electronic facsimile 103 originating from transmit endpoint 114, electronic facsimile 103 can originate elsewhere. For example, electronic facsimile 103 can be loaded directly (without a network connection) into delivery system 102.

In various embodiments, transmit endpoint 114 can be any communication device that transmits electronic documents (e.g., electronic messages) in accordance with various document transfer protocols, including any suitable facsimile (“fax”) protocol. For example, transmit endpoint 114 can be configured to send electronic facsimiles as a public-switched-telephone-network (“PSTN”)-based device in accordance with, for example, a T.30 protocol. As such, transmit endpoint 114 can be a Group 3 device (e.g., T.30 fax machine) configured to communicate via a public-switched-telephone-network. In this case, session request 104 can be configured to establish a connection over a public-switched-telephone-network in accordance with a T.30 protocol.

As another example, transmit endpoint 114 can be configured as a packet-based device to send electronic facsimiles in accordance with a T.38 protocol, or any Fax over Internet Protocol (“FoIP”). In the example shown, transmit endpoint 114 can be configured to send session request 104 to delivery system 102 to initiate a session from transmit endpoint 114. The session can establish either a portion of communication link 101 between transmit endpoint 114 and delivery system 102, or the entire communications link 101 between transmit endpoint 114 and receive endpoint 116, or both, to send an electronic message, such as an electronic facsimile 103.

As used herein, the term “session request” may refer to, at least in one example, a request for a connection between transmit endpoint 114 and a network element, such as call router 105 (or an equivalent thereof), in delivery system 102, or another endpoint. In one embodiment, session request 104 can be a request to establish a connection for exchanging packets over a packet network in accordance with a User Datagram Protocol (“UDP”), a Transmission Control Protocol (“TCP”), and the like. In some embodiments, session request 104 can represent a request in accordance with a signaling protocol, such as a Session Initiation Protocol (“SIP”). One example of SIP is as described by the Internet Engineering Task Force (“IETF”), such as in RFCs. Session request 104 may be accepted by delivery system 102 so as to initiate exchange of packets between transmit endpoint 114 and receive endpoint 116. In some examples, session request 104 may embody and/or accompany an electronic message (e.g., electronic document, or an electronic facsimile) to be routed to receive endpoint 116, which can be associated with an identifier, such as a specific destination address. In another embodiment, session request 104 can be a request from a fax machine (e.g., a T.30-based machine or an equivalent thereof) to establish a connection over a PSTN.

In one embodiment, call router 105 can route electronic facsimile 103 as a unitary electronic document 117 (i.e., as an electronic facsimile in a fax-compatible format, such as TIFF or PDF), or as facsimile components, such as a first subset 123a of facsimile components and a second subset 123b of facsimile components. In one example, a unitary electronic document 117 can be configured to be a contiguous electronic document that can be formatted in a file format suitable for exchanging documents, such as TIFF, PDF, and the like. Note that unitary electronic document 117 can be packetized (e.g., in accordance with TCP/IP) for purposes of transmission, in some embodiments. As another example, consider that delivery system 102 can be configured to generate first subset 123a of facsimile components in accordance with a signaling protocol. Delivery system 102 can be further configured to generate second subset 123b of facsimile components to include image data compliant with a fax protocol, such as a protocol compatible with T.30 as recommended by the International Telecommunication Union (“ITU”), or equivalents thereof, as well as any other fax-compatible protocol. In a specific embodiment, delivery system 102 can be configured to transmit electronic facsimile 103 by, for example, transmitting first subset 123a of facsimile components in compliance with a Session Initiation Protocol (“SIP”), and transmitting second subset 123b of facsimile components in compliance with a fax relay protocol, such as the T.38 protocol, as recommended by the ITU. Other suitable signaling protocols can include H.323, Media Gateway Control Protocol (“MGCP”) for distributed Voice over IP systems, as defined in RFC 3435, and the like. Other suitable protocols for transmitting second subset 123b of facsimile components and electronic facsimile 117 include, but are not limited to: I.366.2, which is configured to send faxes over an ATM network (e.g., in real time), FRF.11.1, which specifies the protocols for fax over frame (as set forth by the MPLS and Frame Relay Alliance), and the like.

In at least one embodiment, delivery system 102 can be configured to interact with multiple receive endpoints 116. As such, call router 105 may “fork,” or replicate, session request 104 to establish one or additional communication links (not shown) to other receive endpoints 116 (not shown). As used herein, the term “fork” refers generally, to splitting or replicating session request 104 to from multiple session requests that can be sent to multiple receive endpoints. In still other examples, receive endpoint 116 and the other receive endpoints 116 may be online simultaneously. Electronic facsimile 103 can be delivered to, for example, the first available receive endpoint (e.g., any of either receive endpoint 116 or other receive endpoints) that responds, or otherwise initiates reception of electronic facsimile 103.

In various examples, the identifier for a destination may be indicated, generally, by destination address, by name, by telephone number, by IP address, or any other identifier. In other examples, delivery system 102 may include repository 106 to store status notification identifier 122a for indicating a recipient status associated with receive endpoint 116. The terms “recipient status” and “recipient state” can refer to, at least in one example, a condition or attribute (or a representation thereof) of a receiving endpoint describing whether that endpoint is either available (e.g., described as a first recipient state) or unavailable (e.g., described as a seconded recipient state) for receiving an electronic message. For example, if receive endpoint 116 is a computing device including an electronic facsimile application, then the computing device can be said to be “available” when coupled to a network, such as the Internet, and can be said to be “unavailable” when the computing device is not coupled to the network.

In various embodiments, receive endpoint 116 may be coupled via a feedback path 177 to repository 106 in delivery system 102. In at least one embodiment, feedback signals can include a status notification message 122a that can be fed back to delivery system 102 (e.g., either periodically or aperiodically). Status notification message 122a can be configured to specify whether receive endpoint 116 is associated with a first recipient state (e.g., is available) or is associated with a second recipient state (e.g., is unavailable). In one embodiment, status notification message 122a (as well as status notification message 122b) can be transmitted as a “stay-alive” or a “keep alive” signal. Repository 106 can be configured to maintain one or more recipient states (or data representations thereof) as set forth in status notification message 122a, as well as online status indicator 118 and offline status indicator 120 (or data representations thereof). In operation, delivery system 102 can, at least in accordance with one embodiment, determine that receive endpoint 116 is associated with a first recipient state (e.g., is available), and then can associate receive endpoint 116 with an identifier, such as a destination identifier (e.g., a fax number), in repository 106. Delivery system 102 can receive destination data, such as data representing the destination fax number, for electronic facsimile 103 from transmit endpoint 114. Routing logic 108 can be configured to determine whether there is a match between the destination data and the identifier. If so, call action logic 110 can be configured (e.g., by routing logic 108) to route electronic facsimile 103 via communications link 101, which excludes a storage device that otherwise can be configured to store electronic facsimiles as, for example, a unitary electronic document 117. In this case, the match can be indicated and/or specified by an on-line status indicator 118 (or a data representation thereof). Note that stored status notifications (e.g., status notification message 122a) in repository 106 can help determine the functionality of routing logic 108. For example, routing logic 108, in response to the state of on-line status indicator 118 can be configured to provide various routing requirements (e.g., to route an electronic message either directly or indirectly), which can be based on receive endpoint 116 delivery preferences. Examples of such delivery preferences include sending to another destination if a first destination is unavailable, generating multiple copies of electronic facsimile 103 (e.g., when transmitted once) and sending those multiple copies to several destinations simultaneously (or nearly simultaneously), or in sequence, whereby the first responding receive endpoint can be designated to receive the first fax session, and the like. As such, receive endpoint 116 can be configured to modify the functionality of delivery system 102 by, for example, mandating storage in network storage 112 regardless of the availability of receive endpoint 116. This action can be set as a delivery preference as well.

In one embodiment, routing logic 108 can be configured to determine that there is no match (i.e., there is no status match) between the destination data and the identifier. If there is no match, then this signifies that the identifier is absent, and, thus, the receiving endpoint is not available. For example, the absence of the identifier in repository 106 for the receiving endpoint can indicate that the receiving endpoint is off-line/unavailable. But if there is a match (e.g., there is a status match), call action logic 110 can be configured (e.g., by routing logic 108) to route electronic facsimile 103 as electronic facsimile 119 via network storage 112 to receive endpoint 116. A match between the destination data and the identifier indicates that the identifier for the receiving endpoint is present (e.g., in repository 106), which indicates that the receiving is on-line/available. In various instances, electronic facsimile 119 can be a unitary electronic document, or can be transmitted as separable fax components, such as 123a and 123b. As such, delivery system 102 can store electronic facsimile 103 if, for example, status notification message 122b indicates that receive endpoint 116 is not available to receive delivery (i.e., it is offline, as identified by offline status indicator 120). But if status notification message 122b indicates that receive endpoint 116 is available (e.g., at some later time), then network storage 112 can release electronic facsimile 119 to receive endpoint 116. Note that network storage 112 may include network elements to render, store, and forward messages.

As used herein, the term “electronic facsimile” refers generally, at least in one embodiment, to an electronic message that can be formed to include an electronic document, in compliance with specific protocols, such as those associated with ITU T.30 and T.38, or the like. As used herein, the term “electronic document,” can refer, at least in one embodiment, to any data file (e.g., other than computer programs or system files) that are intended to be used in their electronic form, without necessarily being printed, whereby computer networks and electronic display technologies can help facilitate their use and distribution. In one embodiment, an electronic document can be included in or form an electronic message, such as an electronic facsimile. The electronic document may be transmitted over the network using special protocols such as T.38 (i.e., a known protocol for real-time fax transmissions across an IP-based network) using User Datagram Protocol (“UDP”) or Transmission Control Protocol (“TCP”) to process packets across the network. As used herein, the term “node” refers generally, at least in one example, to a device as being connected to a computer network (e.g., fax network). For example, a node may be a computer, fax machine, personal digital assistant, cell phone, router, switch, or hub. In some instances, a node is an endpoint, such as transmit endpoint 114 and receive endpoint 116. As used herein, the term “network element” refers generally, at least in one example, to an element within or without delivery system 102 that includes computing hardware and/or software for facilitating network communications, and can also refer to a call router (e.g., as a server or as a software module), a fax server, a proxy server, and the like.

In various embodiments, delivery system 102 can provide for delivery over communications link 101 (e.g., in response to an online status identifier 118), and can provide for a storing operation (e.g., in response to an online status identifier 120), either of which may be enabled during different sessions. As such, delivery system 102 can provide only direct delivery (e.g., real-time transmission or substantially real-time transmission) for a session, according to one embodiment. In various examples, delivery system 102 may be configured to facilitate sending (or receiving) an electronic facsimile (“fax”) between two or more fax nodes. Examples of such fax nodes include analog group 3 (“T.30”) devices, real-time IP-based (“T.38”) devices, client-driven email applications, cellular phone message applications, and other packet-based communication devices such as voice-over-internet-protocol (“VoIP”) devices.

Note that one or more of transmit endpoint 114, delivery system 102, and receive endpoint 116, can be configured to support the display of the real-time progress of electronic facsimile 103 (or portions thereof) when transmitted via communications link 101. Communications link 101 is shown, at least in this example, to exclude storage that otherwise might impinge on an ability to present real-time progress (or substantially real-time progress) to a user at transmit endpoint 114. An example of real-time progress can include identifying each page (on a page-by-page basis) that is received by a fax machine. In at least one example, delivery system 102 may implement a handshaking process to delegate processing services from at least one network element (e.g. call router 105) to another network element (e.g., such as a fax server in network storage 112), which is not shown. The handshaking process may occur when call action logic 110 selects a route to store electronic facsimiles prior to delivery. In other examples, delivery system 102 and the above-described elements (i.e., the elements shown and/or indicated by reference numerals above) may be implemented differently in various designs, operations, configurations, and materials, and are not limited to the descriptions provided herein.

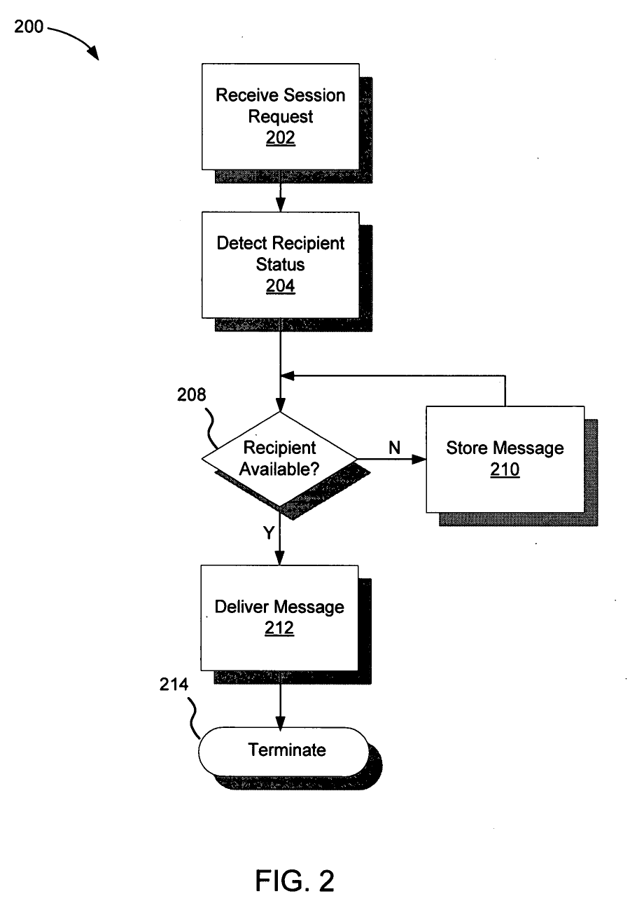

FIG. 2 illustrates an example of a flow chart for a real-time electronic facsimile delivery system, according to at least one embodiment of the invention. Here, flow 200 begins at 202, with a session request being received at delivery system 102 (FIG. 1), which can be associated with an electronic facsimile. At 204, a recipient status is detected, for example, during examination of a registry, which can be implemented in repository 106. Such a registry can include indications that specific receive endpoints are available to receive electronic facsimiles over a delivery path, such as communication link 101 (FIG. 1). Flow 200 may determine at 208 whether the recipient is available. If so, flow 200 moves to 212 to deliver the electronic facsimile. At 214, flow 200 can terminate. If not, flow 200 moves to 210 to store the electronic facsimile, returning to 208 in the event that the recipient subsequently becomes available. In other examples, flow 200 and the above-described elements (i.e., the elements shown and/or indicated by reference numerals above) may be implemented differently in different designs, operations, configurations, and materials, and are not limited to the descriptions provided herein.

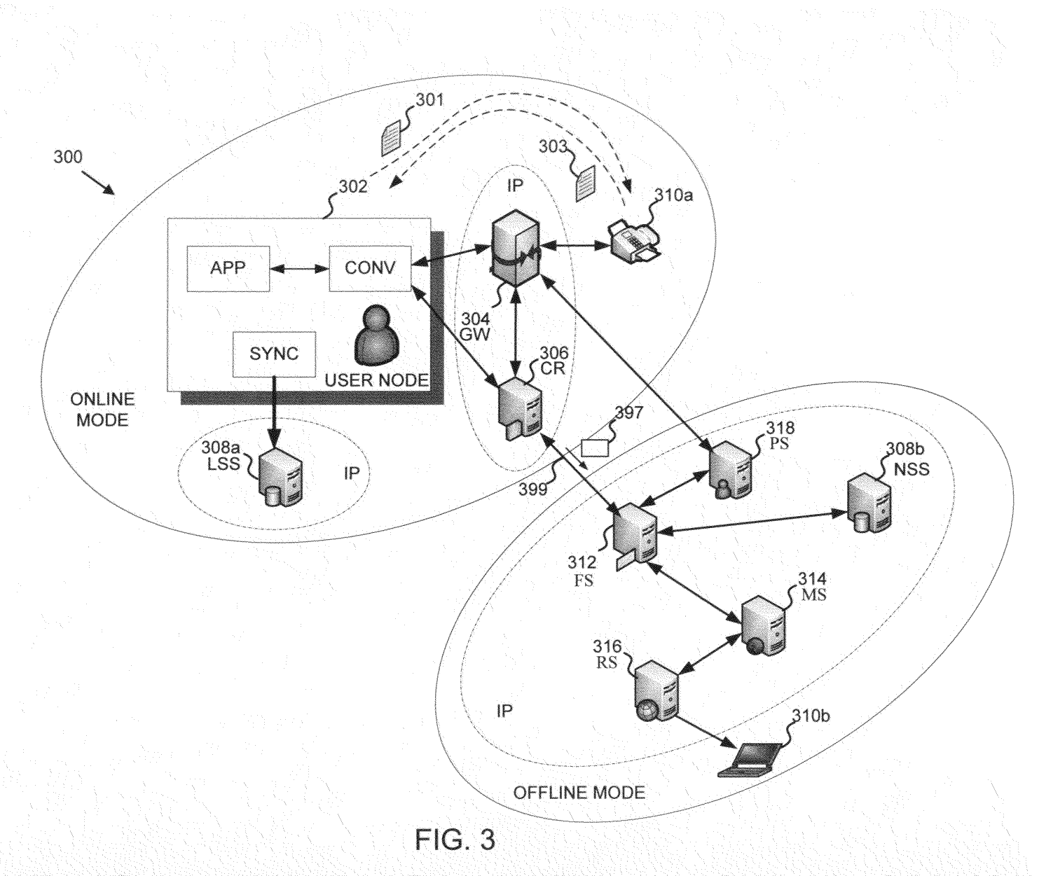

FIG. 3 illustrates an example of a delivery system operating in at least two modes of operation, according to at least one embodiment of the invention. Here, system 300 includes a user node 302, a gateway (“GW”) 304, a call router (“CR”) 306, a local storage server (“LSS”) 308a, a network storage server (“NSS”) 308b, fax nodes 310a-b, a fax server (“FS”) 312, a message server (“MS”) 314, a rendering server (“RS”) 316, and a protocol server (“PS”) 318. In some examples, system 300 may operate in an online mode when a recipient status specifies that either user node 302 is available to receive messages (e.g., electronic facsimiles 303) from fax node 310a, which can be a PSTN-based device, or fax node 310a is available to receive an electronic facsimile 301 from user node 302. In view of the foregoing, system 300 operates in an online mode so long as either user node 302 or fax node 310a remain on-line for receiving electronic facsimiles 301 and 303. But if either user node 302 or fax node 310a is to receive a fax, but is not on-line, then system 300 operates in an off-line.

To illustrate operation of system 300 in an on-line mode, consider that fax node 310a may send a message as electronic facsimile 303 to gateway 304, which then delivers electronic facsimile 301 to user node 302 with delivery provisions from call router 306. For example, a delivery provision can specify the use of a specific signaling protocol that can accompany encapsulated image date (e.g., T.30 data encapsulated as T.38 data packets). As used herein, the term “call router” may refer, generally, to being a proxy server facilitating communications between a client and a different server. In one example, call router 306 may provision electronic facsimile 303 using a session initiation protocol (“SIP”) as the signaling protocol to create, modify, and terminate sessions. In other examples, user node 302 may send electronic facsimile 301 to gateway 304 to deliver the electronic facsimile directly to fax node 310a. In this case, call router 306 may provision the delivery to fax node 310a.

To illustrate operation of system 300 in an off-line mode, consider that system 300 can enter the off-line mode of operation when a recipient status indicates that, for example, fax node 310b is not available to receive an electronic facsimile. Call router 306 may delegate the provision of the delivery to fax server 312 when fax node 310b is unavailable. Specifically, at least in some cases, call router 306 is configured to route the calls to fax server 312 (e.g., rather than transmitting the calls to an endpoint). For example, system 300 may implement a handshaking process to delegate processing services from at least one network element, such as call router 306, to another network element, such as fax sever 312, when operating in offline mode (such as is the case when node 310b is not available). In some cases, the handshaking process may use a path 399 to send a delegation message 397 to fax server 312, which can be information and/or instructions on how to provision the delivery of electronic facsimiles during the offline mode.

In other examples, fax server 312 may delegate provisioning of the electronic facsimile from gateway 304 to protocol server 318. In this case, protocol server 318 may convert the electronic facsimile into a digital file constructed of a number of packets (i.e., to be delivered in an IP network) and be routed to message server 314 for storage. As such, message server 314 can be implemented as a storage device. In some examples, message server 314 may be also be configured to operate as a web server that can include a computer program for facilitating, for example, HTTP-based communications. In still other examples, message server 314 may be implemented to provide dynamic intermediate storage on a network, whereby message server 314 may route the electronic facsimile to rendering server 316, and dynamically generate an image (e.g., in a fax-compliant format, such as a TIFF file) to be displayed at fax node 310b after delivery. In some examples, rendering server 316 may facilitate pre-rendered messages. In still other examples, fax server 312 may interact with database 308b to access account information (e.g., call detail records) pertaining to subscribers (e.g., users who have accounts to use delivery service) on the network. As such, system 300 can meter usage for delivery of messages and storage of messages as a function of account information (e.g., whether a subscriber is prepaid). In some examples, system 300 and the above-described elements (i.e., the elements shown and/or indicated by reference numerals above) may be implemented differently in various designs, operations, configurations, and materials, and are not limited to the descriptions provided herein.

In various examples, user node 302 may be a client device such as a personal computer, a smart phone, a fax machine, and other electronic communication device. User node 302, may be implemented to host application software interfacing with a conversion component configured to terminate messages using real-time (or substantially real-time) IP-based protocols. In some examples, system 300 may implement local storage server 308a to interface with user node 302. As used herein, the term “online” may refer to being connected to a system and/or “available” for operation. For example, the term “online” may refer to being available for use on demand by the system. Further, the term online may refer to being logged-in to the system. As used herein, the term “directly” refers generally, at least in one example, to being connected endpoint-to-endpoint without, for example, an intervening storage operation. As such, a message may be delivered as soon as it is detected, and, thereby need not require intermediate storage. As used herein, the term “offline” may refer to being disconnected from a system and/or “unavailable” for operation.

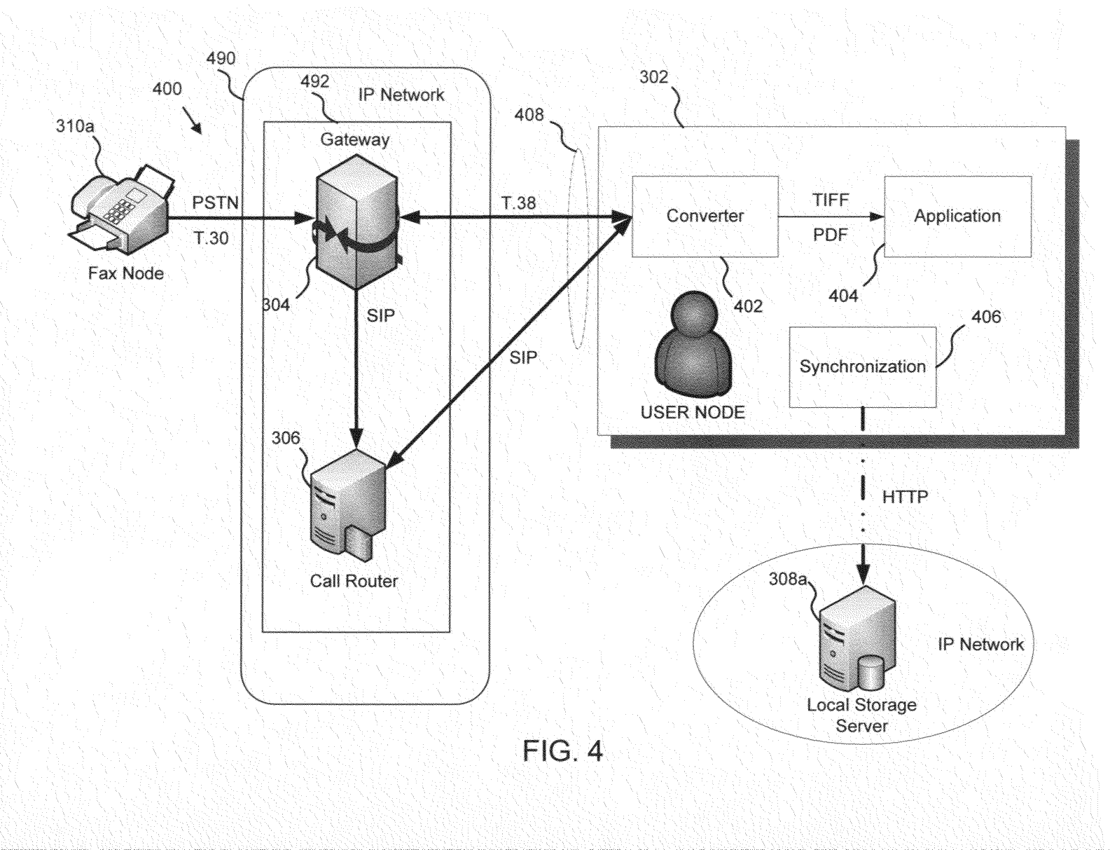

FIG. 4 illustrates an example of an endpoint-to-endpoint real-time facsimile receiving system, according to at least one embodiment of the invention. Here, system 400 includes a user node 302, a gateway 304, a call router 306, a local storage server 308a, a fax node 310a, a conversion component 402, an application 404, a synchronization interface 406, and a network interface 408. In some examples, system 400 may be implemented to receive electronic facsimiles when online. In other examples, user node 302 may send signals (e.g., periodically) via a network 490 (e.g., IP network) to notify delivery system 492 (including gateway 304 and/or call router 306) of its presence on network 490, thus signifying that user node 302 is online. In still other examples, user node 302 may be implemented to receive encapsulated messages following a protocol (e.g., T.38 protocol) for use on an IP network. In some examples, there may be multiple user nodes 302 (not shown) that can be available to receive electronic facsimiles. Communication with the multiple user nodes 302 may be established when, for example, one of the user nodes online responds first to delivery system 492.

In other examples, fax node 310a sends a message over a telephony network (e.g., PSTN) using conventional protocols for use on PSTN such as T.30 (e.g., Group 3). Gateway 304 receives the electronic facsimile from fax node 310a and determines user node 302 is online. Call router 306 provisions the delivery of the electronic facsimile to user node 302 using SIP over the IP network. In some examples, the delivery over the IP network may support displaying real-time progress to fax node 310a and user node 302. In other examples, user node 302 may include converter 402, which can include a conversion component (e.g., an SIP/T.38 conversion component) to facilitate the conversion process (or the formatting process) of converting an encapsulated message into a fax-compatible document, as a reproduction of the originally sent electronic facsimile. As such, converter 402 can be configured to terminate data communications formatted in fax-related protocols, such as T.38. In one example, converter 402 may implement control logic to handle packets undergoing conversion. Application 404 includes executable instructions and/or logic that are configured to communicate with delivery system 492 so as to exchange signaling messages (e.g., in accordance with a signaling protocol) and image data (e.g., in accordance with a fax-compliant protocol, such as T.38). Further, 404 can include instructions for generating and transmitting messages indicative of the availability of node 302. In still other examples, user node 302 may include synchronization interface 406 to synchronize the messages (e.g., electronic facsimiles) in storage server 308a with those available on network 490 or received therefrom. User node 302 may implement network interface 408 to support real-time protocol solutions (e.g., SIP, T.38) over the IP network.

In a specific embodiment, node 302 can be configured to report a recipient status from a receiving node, such as user node 302, via a packet network (e.g., IP network 490) to an electronic facsimile delivery system 492. Node 302 includes a converter to convert encapsulated data for an electronic facsimile at node 302 into a fax-compatible format.

In still other examples, user node 302 may interact with a registration interface that may be coupled to a web portal. The web portal can be established in association with, for example, message server 314, which can be configured to operate as a web server. The user information may provide routing requirements for use by call router 306 when provisioning the delivery of the electronic facsimile. In some examples, user node 302 may provide status signals (e.g., status notification message 122 of FIG. 1) to call router 306 using periodic intervals based on a framing signal from the network. In some examples, system 400 and the above-described elements (i.e., the elements shown and/or indicated by reference numerals above) may be implemented differently in design, operation, configuration, and materials, and are not limited to the descriptions provided herein.

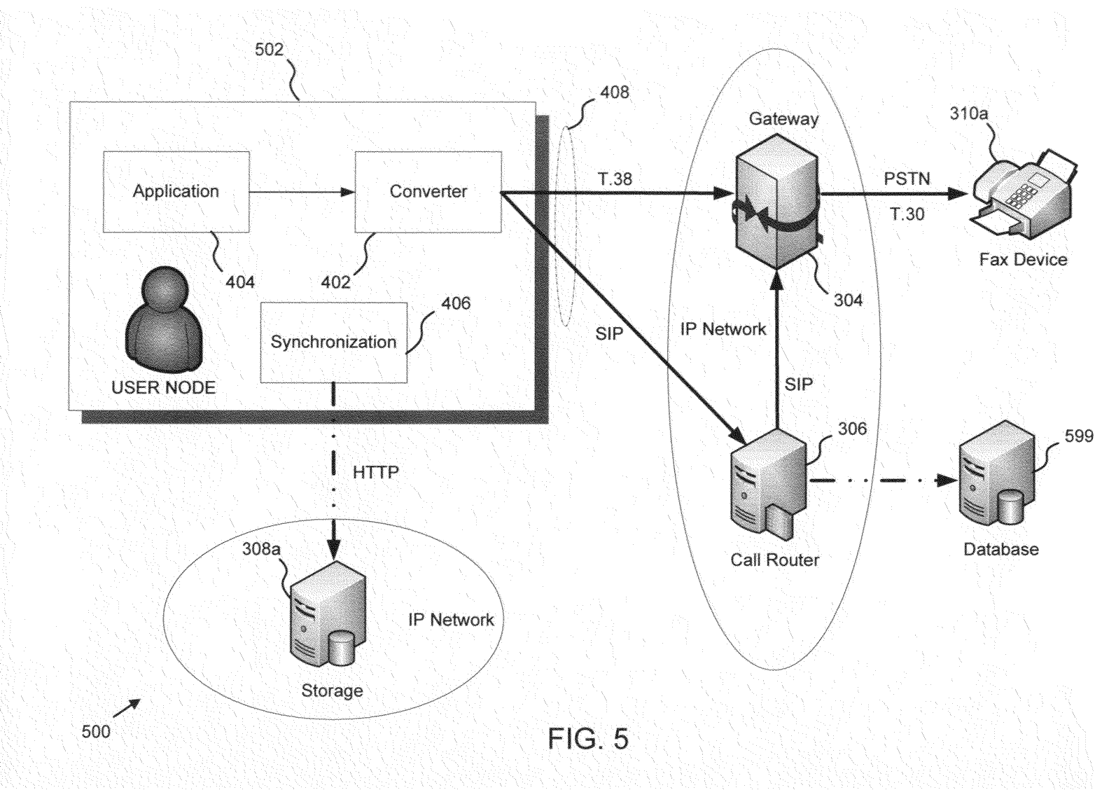

FIG. 5 illustrates an example of an endpoint-to-endpoint real-time facsimile sending system, according to at least one embodiment of the invention. Here, system 500 includes a user node 502, a gateway 304, a call router 306, a storage server 308a, a fax node 310a, a converter 402, an application 404, a synchronization interface 406, a network interface 408, and a database 502. In some examples, system 500 may be implemented to send electronic facsimiles from user node 502 when online. User node 502 may implement application 404 to provide delivery information including destination addressing to which to send an electronic facsimile. In other examples, user node 502 may implement converter 402 to encapsulate messages following a protocol (e.g., encapsulate data in accordance with T.38 protocol) for use on an IP network.

In other examples, fax node 310a can be configured to receive an electronic fax over a telephony network (e.g., PSTN) using known protocols for use on PSTN such as T.30 (e.g., Group 3). Gateway 304 can be configured to receive the electronic facsimile from user node 502 and determines fax node 310a is online. Call router 306 provisions the delivery of the electronic facsimile to fax node 310a using SIP over the IP network. In some examples, the delivery over the IP network may support real-time (or substantially real-time) progress to fax node 310a and user node 502. In other examples, user node 502 may include synchronization interface 406 to transfer messages with storage server 308a available on the network. In some examples, call router 306 may interact with database 599 to monitor and detect call details of fax node 310a. In other examples, user node 502 may implement network interface 408 to support real-time protocol solutions (e.g., SIP, T.38) over the IP network. In still other examples, user node 502 may store messages locally (e.g., at user personal computer) prior to delivery of messages. In some examples, system 500 and the above-described elements (i.e., the elements shown and/or indicated by reference numerals above) may be implemented differently in design, operation, configuration, and materials, and are not limited to the descriptions provided herein.

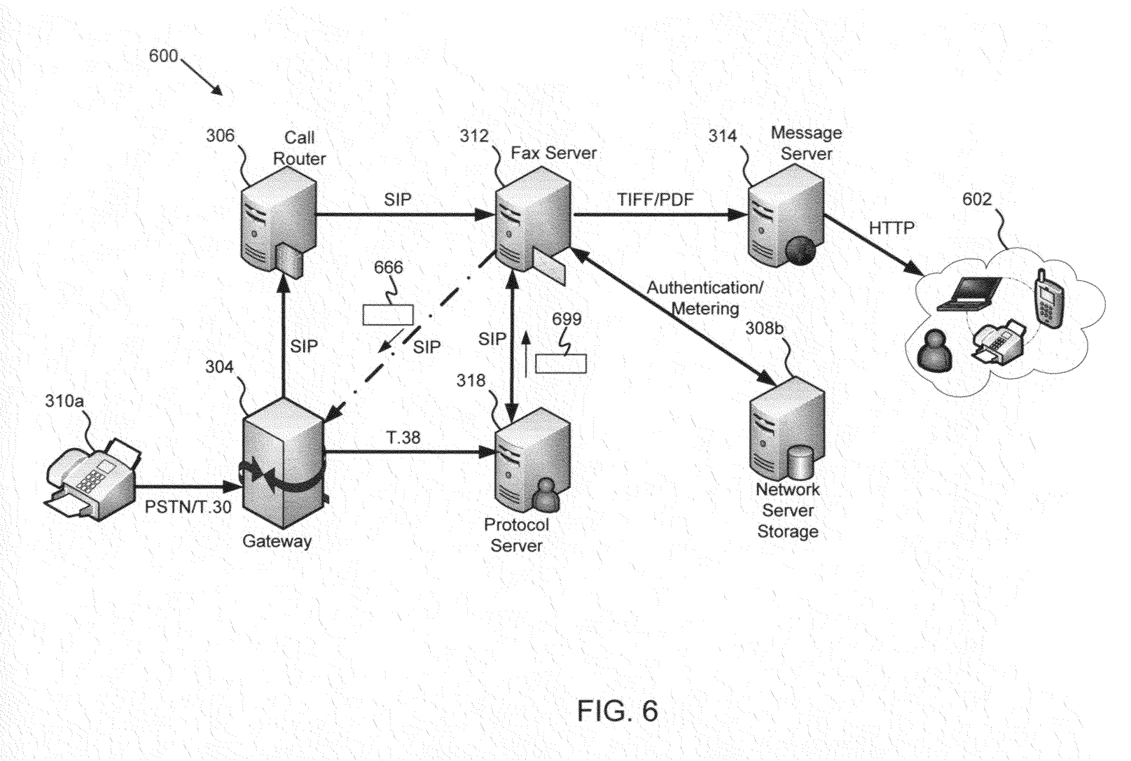

FIG. 6 illustrates an example of an endpoint-to-server facsimile receiving system, according to at least one embodiment of the invention. Here, system 600 includes a gateway 304, a call router 306, a storage server 308b, a fax node 310a, a fax server 312, a message server 314, a protocol server 318, and a user receive node 602. In some examples, when user receive node 602 is offline, a path between fax node 310a and at least one network element may be established. The path may provide storage of a message and placed in queue for later delivery to user receive node 602. User receive node 602 may provide user information with preferences how to retrieve stored messages.

In some examples, fax node 310a transmits a message to gateway 304 to be routed through a network providing storage capabilities based on recipient status. Call router 306 in conjunction with fax server 312 can be configured to provision the transmission of the electronic facsimile. In some embodiments, fax server 312 may be delegated to provision electronic facsimile deliveries. As such, fax server 312 can guide communications from gateway 304 to protocol server 318 using a message 666 via SIP, whereby message 666 identifies a specific protocol server 318 associated with the delivery of an electronic facsimile. Fax server 312 interfaces with protocol server 318 using real-time protocols (e.g., SIP, T.38) in order to facilitate the delivery over an IP network. In some examples, protocol server 318 may ping fax server 312 with status of newly stored messages and/or electronic facsimiles. As used herein, the term “ping” refers generally, to prompting or notifying by using signals or an in-storage message 699, which signifies that an electronic facsimile has been stored. Once fax server 312 receives in-storage message 699, fax server 312 then can schedule delivery of the electronic facsimile. Message server 314 may provide services to handle requests from other network elements (e.g., fax server 312, call router 306) and provide responses during a session. In addition, message server 314 may store an electronic version of the electronic facsimile to be retrieved by or delivered to user receive node 602. In other examples, fax server 312 may interact with database 308b to access account information pertaining to subscribers (e.g., users who have accounts to use delivery service) on the network. The account information may meter usage for delivery of messages and storage of messages. In still other examples, user receive node 702 may be implemented to include a personal computer, a personal digital assistant, a smart-phone, a fax machine, and any other communication device capable of displaying a fax-compatible document.

In some examples, system 600 and the above-described elements (i.e., the elements shown and/or indicated by reference numerals above) may be implemented differently in design, operation, configuration, and materials, and are not limited to the descriptions provided herein.

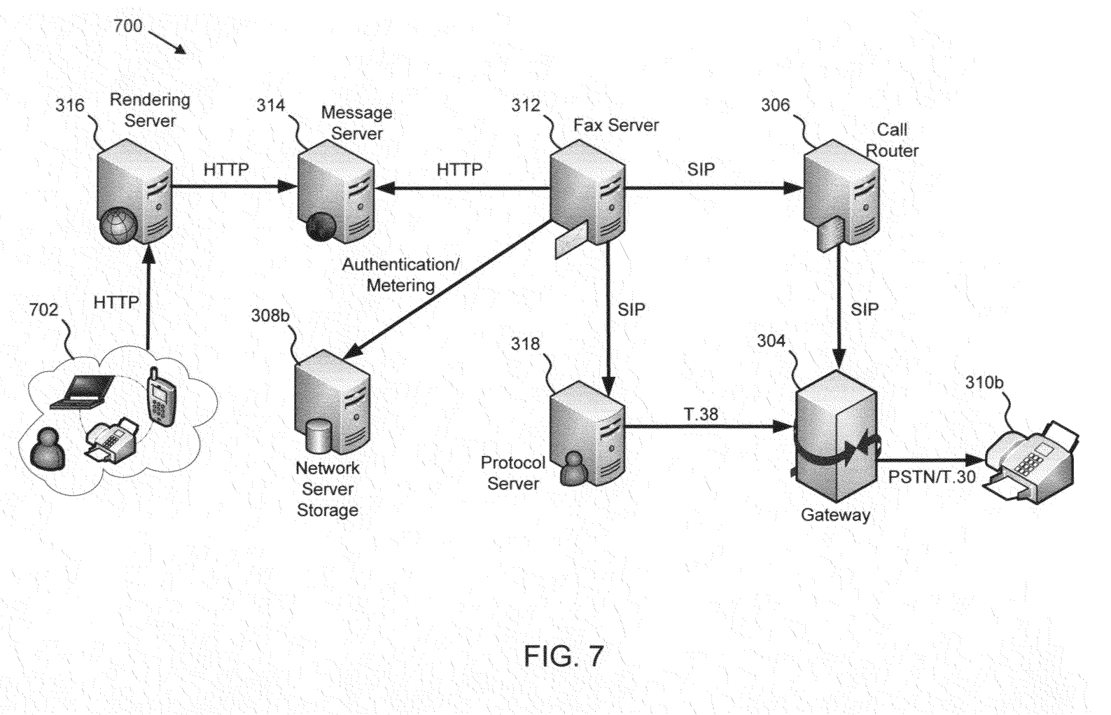

FIG. 7 illustrates an example of an endpoint-to-server facsimile sending system, according to at least one embodiment of the invention. Here, system 700 includes a gateway 304, a call router 306, a storage server 308b, a fax node 310b, a fax server 312, a message server 314, a rendering server 316, a protocol server 318, and a user sending node 702. In some examples, when fax node 310b is offline, a path between user send node 702 and at least one network element may be established. The path may provide storage of a message and placed in queue for later delivery to fax node 310b. User send node 702 may provide instructions or preferences as to how to deliver messages to fax node 310b. In some examples, user send node 702 transmits a message to gateway 304 to be routed through a network providing storage capabilities based on recipient status (e.g., status from fax node 310b). Call router 306 in conjunction with fax server 312 provisions the transmission of the electronic facsimile. Fax server 312 interfaces with protocol server 318 using real-time protocols (e.g., SIP, T.38) in order to facilitate the delivery over an IP network. In some examples, protocol server 318 may ping fax server 312 with a status that is indicative of the delivery progress of an electronic facsimile (e.g., by providing a status indicator). Message server 314 may provide services to handle requests from other network elements (e.g., fax server 312, call router 306, and the like) and provide responses during a session. In addition, message server 314 may store an electronic version (i.e., digital format) of the electronic facsimile to be retrieved by or delivered to fax node 310b. In other examples, fax server 312 may interact with database 308b to access calling detail records (e.g., subscriber information, message details) on the network. The account information may meter usage for delivery of messages and storage of messages. In still other examples, user send node 602 may be implemented to include a personal computer, a personal digital assistant, a smart-phone, a fax machine, and any other communication device capable of displaying a fax-compatible document.

In some examples, system 700 and the above-described elements (i.e., all elements shown and indicate by reference numerals above) may be implemented differently in design, operation, configuration, and materials, and are not limited to the descriptions provided herein.

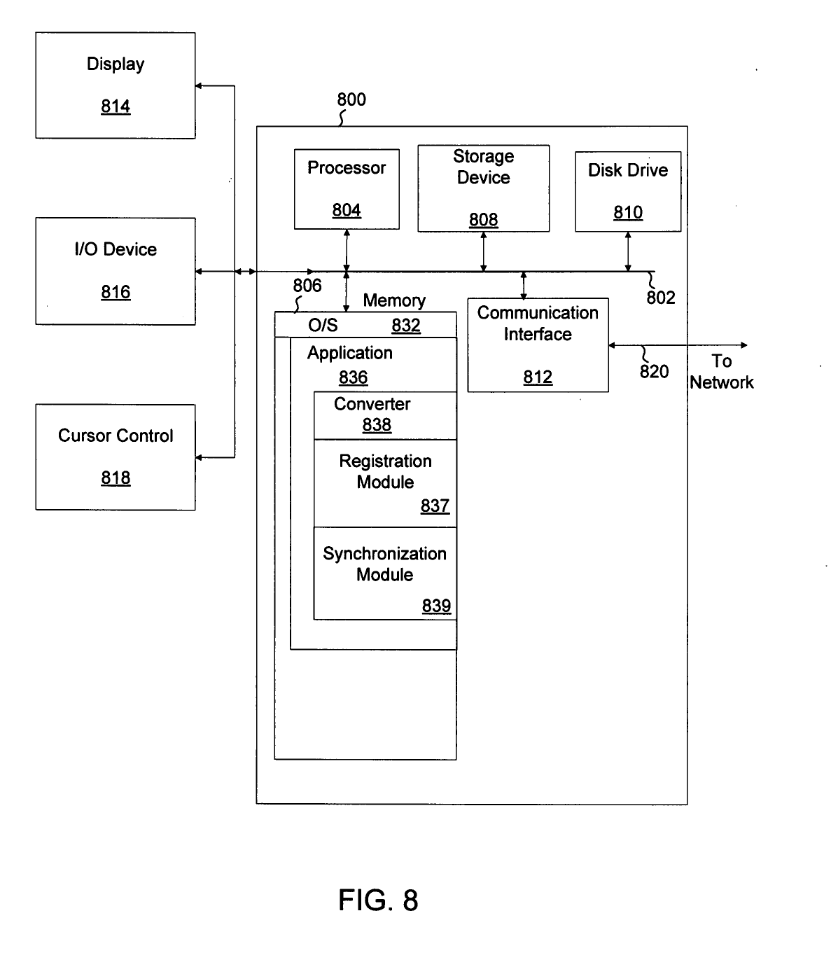

FIG. 8 illustrates an exemplary computer system suitable for generating electronic facsimiles, according to at least one embodiment of the invention. In some examples, computer system 800 can be used to implement computer programs, applications, methods, processes, or other software to perform the above-described techniques and to realize the structures described herein. Computer system 800 includes a bus 802 or other communication mechanism for communicating information, which interconnects subsystems and devices, such as a processor 804, a system memory (“memory”) 806, a storage device 808 (e.g., ROM), a disk drive 810 (e.g., magnetic or optical), a communication interface 812 (e.g., modem or Ethernet card), a display 814 (e.g., CRT or LCD), an input device 816 (e.g., keyboard), and a pointer cursor control 818 (e.g., mouse or trackball). In one embodiment, pointer cursor control 818 invokes one or more commands that, at least in part, modify the rules stored, for example in memory 806, to define the electronic facsimile generation process (for either sending or receiving, or both).

According to some examples, computer system 800 performs specific operations in which processor 804 executes one or more sequences of one or more instructions stored in system memory 806. Such instructions can be read into system memory 806 from another computer readable medium, such as static storage device 808 or disk drive 810. In some examples, hard-wired circuitry can be used in place of or in combination with software instructions for implementation. In the example shown, system memory 806 includes modules of executable instructions for implementing an operation system (“O/S”) 832, an application 836 (e.g., a host, server, web services-based, distributed (i.e., enterprise), application programming interface (“API”), program, procedure or others). Further, application 836 includes a module of executable instructions for implementing a converter 838, as well as modules of executable instructions for implementing a registration module 837 and a synchronization module 839. Converter module 838 includes instructions for use T.38-based data and SIP-based data to generate an electronic facsimile. In some cases, converter module 838 can include instructions for providing application-layered control logic, such as SIP control logic. Registration module 837 can be configured to generate recipient state notification messages to indicate whether computing system 800 is available. Synchronization module 839 includes instructions for interfacing to local storage and for synchronizing files for electronic facsimiles between the two.

The term “computer readable medium” refers, at least in one embodiment, to any medium that participates in providing instructions to processor 804 for execution. Such a medium can take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 800. According to some examples, two or more computer systems 800 coupled by communication link 820 (e.g., LAN, PSTN, or wireless network) can perform the sequence of instructions in coordination with one another. Computer system 800 can transmit and receive messages, data, and instructions, including program code (i.e., application code) through communication link 820 and communication interface 812. Received program code can be executed by processor 804 as it is received, and/or stored in disk drive 810, or other non-volatile storage for later execution. In one embodiment, system 800 is implemented as a hand-held device. But in other embodiments, system 800 can be implemented as a personal computer (i.e., a desktop computer) or any other computing device. In at least one embodiment, any of the above-described delivery systems can be implemented as a single system 800 or can implemented in a distributed architecture including multiple systems 800, one of which can be a caller router, as described above.

In view of the foregoing, examples of a real-time electronic facsimile delivery system are described. Electronic facsimile delivery systems may be implemented using real-time interfaces that are configured to control and manage communication over an IP network. Further electronic facsimile delivery systems may be implemented using feedback paths to monitor status from destination points (e.g., fax nodes) to determine delivery options. The described techniques may be used to emulate other electronic facsimile technologies by delivering fax messages independent of storing.

In other examples, electronic facsimile delivery systems may be implemented from a sending fax node to a receiving fax node. The fax nodes (e.g., sending fax node, receiving fax node) can be of the form of a personal computer, a computing device, a mobile device, a mobile telephone, a facsimile device, a personal digital assistant (“PDA”) or other electronic device. Messages can be of the form of email messages, facsimiles, text messages, short messaging service (“SMS”), web pages, audible messages, multimedia messaging service (“MMS”), or other message types. Various embodiments can apply to any electronic message and are not limited to electronic facsimiles.

In at least some of the embodiments of the invention, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, and others. These can be varied and are not limited to the examples or descriptions provided.

The foregoing description, for purposes of explanation, used specific nomenclature to provide a thorough understanding of the invention. However, it will be apparent to one skilled in the art that specific details are not required in order to practice the invention. In fact, this description should not be read to limit any feature or aspect of the present invention to any embodiment; rather features and aspects of one embodiment can readily be interchanged with other embodiments.

Thus, the foregoing descriptions of specific embodiments of the invention are presented for purposes of illustration and description. They are not intended to be exhaustive or to limit the invention to the precise forms disclosed; many alternatives, modifications, equivalents, and variations are possible in view of the above teachings. For the purpose of clarity, technical material that is known in the technical fields related to the embodiments has not been described in detail to avoid unnecessarily obscuring the description. Thus, the various embodiments can be modified within the scope and equivalents of the appended claims. Further, the embodiments were chosen and described in order to best explain the principles of the invention and its practical applications; they thereby enable others skilled in the art to best utilize the invention and various embodiments with various modifications as are suited to the particular use contemplated. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and their equivalents define the scope of the invention.

1. A method of delivering electronic facsimiles using an electronic facsimile delivery system deployed in a network, comprising:
storing a plurality of identifiers in a repository of the electronic facsimile delivery system, each of the identifiers corresponding to one of a plurality of receiving nodes and having data associated therewith representing a recipient state that indicates whether the corresponding receiving node is available on the network;
receiving destination data with the electronic facsimile delivery system from a plurality of transmit nodes via the network, the destination data representing a plurality of destinations for a corresponding plurality of electronic facsimiles from corresponding ones of the transmit nodes, the destination data identifying at least some of the receiving nodes;
determining with reference to the stored identifiers availability of the receiving nodes identified by the destination data to receive corresponding ones of the electronic facsimiles;
transmitting a first subset of the electronic facsimiles via the network to the corresponding receiving nodes when the receiving nodes corresponding to the first subset of the electronic facsimiles are determined to be available; and
storing a second subset of the electronic facsimiles in the electronic facsimile delivery system when the receiving nodes corresponding to the second subset of the electronic facsimiles are determined to be unavailable;
wherein at least some of the transmit nodes and at least some of the receiving nodes access the electronic facsimile delivery system via a public portion of the network.

2. The method of claim 1, wherein transmitting a first one of the electronic facsimiles comprises:
responsive to determining that a first one of the receiving nodes corresponding to the first electronic facsimile is available, establishing a communication link to the first receiving node; and
transmitting the first electronic facsimile via the communication link without storing the first electronic facsimile as part of the communication link.

3. (canceled)

4. The method of claim 1, wherein transmitting a first one of the electronic facsimiles comprises:
transmitting the first electronic facsimile as a first subset of facsimile components and a second subset of facsimile components.

5. The method of claim 4, further comprising:
generating the first subset of facsimile components in accordance with a signaling protocol; and
generating the second subset of facsimile components to include image data compliant with a fax protocol.

6. The method of claim 1, wherein transmitting a first one of the electronic facsimiles comprises:
transmitting a first subset of facsimile components that are compliant with a Session Initiation Protocol (“SIP”) and a second subset of facsimile components that are compliant with a T.38 protocol.

7. (canceled)

8. (canceled)

9. The method of claim 1, further comprising:
generating an in-storage message indicating that a first one of the electronic facsimiles is stored; and
scheduling delivery of the first electronic facsimile in response to the in-storage message.

10. The method of claim 1, further comprising:
displaying real-time progress to a first one of the transmit nodes of delivery of one or more portions of a corresponding one of the electronic facsimiles to the corresponding receiving node.

11. A method of receiving electronic facsimiles from an electronic facsimile delivery system via a network, comprising:
reporting a recipient status by a receiving node via the network to the electronic facsimile delivery system, the reporting including the receiving node transmitting status notification signals configured to cause the electronic facsimile delivery system to associate a recipient state with the receiving node in a repository of the electronic facsimile system, the recipient state indicating whether the receiving node is coupled to the network;
receiving first encapsulated data for a first electronic facsimile originating from a transmit node via a communication link when the recipient state indicates that the receiving node is coupled to the network;
receiving second encapsulated data for a second electronic facsimile from the electronic facsimile delivery system, the second encapsulated data having been previously stored by the electronic facsimile delivery system in response to the recipient state indicating that the receiving node was not coupled to the network; and
converting the encapsulated data at the receiving node into a fax-compatible format
wherein the receiving node accesses the electronic facsimile delivery system via a public portion of the network.

12. (canceled)

13. The method of claim 11, wherein receiving the first encapsulated data comprises:
interfacing with a data stream from the network that includes signaling information in a different form than image data for the first electronic facsimile.

14. The method of claim 11, wherein converting the encapsulated data comprises:
converting data formatted in accordance with a fax relay protocol into a Tagged Image File Format (“TIFF”)-based electronic facsimile.

15. The method of claim 14, wherein converting data formatted in accordance with the fax relay protocol comprises:
extracting the data for the TIFF-based electronic facsimile from the encapsulated data formatted in accordance with T.38.

16. The method of claim 11, wherein converting the encapsulated data comprises:
terminating SIP signaling data and T.38 data at the receiving node.

17. A method of sending electronic messages between a plurality of transmit nodes and a plurality of receiving nodes using a delivery system in a network, comprising:
pinging a network element to generate pinging results;
using the pinging results to configure communication links for transmission of the electronic messages between corresponding pairs of the transmit and receiving nodes;
determining a state of communication of each of the receiving nodes by receiving and processing status notification signals from each of the receiving nodes, and storing the state of communication for each of the receiving nodes in a repository in the delivery system, the state of communication being indicative of whether the corresponding receiving node is online;
initiating the communication links to corresponding ones of the receiving nodes;
choosing an action for each of the receiving nodes for which the corresponding state of communication indicates the receiving node to be online; and
transmitting electronic messages using the communication links based on the actions; and
storing electronic messages in the delivery system for each of the receiving nodes for which the corresponding state of communication indicates the receiving node to be offline;
wherein at least some of the transmit nodes and at least some of the receiving nodes access the electronic facsimile delivery system via a public portion of the network.

18. The method of claim 17, wherein initiating the communication links comprises:
using application-layered control logic to configure the communication links.

19. The method of claim 17, wherein pinging the network element comprises:
in response to the state of communication for a first one of the receiving nodes indicating the first receiving node is not online, determining that the corresponding electronic message is stored prior to delivery; and
communicating an in-storage message to the network element, thereby specifying that the electronic message corresponding to the first receiving node is stored.

20. (canceled)

21. The method of claim 17, wherein choosing the action for a first one of the receiving nodes comprises:
selecting to route the electronic message corresponding to the first receiving node from a storage device to the first receiving node as a function of the availability of the first receiving node.

22. A non-transitory machine-readable storage device containing one or more computer programs, the one or more computer programs, when executed by one or more processors, operable to:
send a recipient status signal from a receiving node via a network to an electronic facsimile delivery system, the recipient status signal being indicative of the availability of the receiving node, the recipient status signal being configured to cause the electronic facsimile delivery system to associate a recipient state with the receiving node in a repository of the electronic facsimile delivery system, the recipient state indicating whether the receiving node is coupled to the network;
receive encapsulated data for an electronic facsimile in a data stream from the network that includes signaling information in a different form than image data for the electronic facsimile; and
convert at least a portion of the encapsulated data formatted in accordance with T.38 into a Tagged Image File Format (“TIFF”)-based electronic facsimile;
wherein the receiving node accesses the electronic facsimile delivery system via a public portion of the network.

23. The non-transitory, machine-readable storage device containing one or more computer programs of claim 22, wherein the one or more computer programs are further operable to:
generate a first subset of fax components and a second subset of fax components to transmit another electronic facsimile; and
convert the first subset of fax components and the second subset of fax components into another TIFF-based electronic facsimile.

24. The method of claim 1, further comprising:
receiving a status notification message from a first one of the receiving nodes that specifies whether the first receiving node is associated with (i) a first recipient state indicating the first receiving node is connected to the network, or (ii) a second recipient state indicating the first receiving node is not connected with the network;
determining whether the first receiving node is available to receive a first one of the electronic facsimiles over the network by:
determining whether the recipient state corresponding to the first receiving node comprises the first recipient state or the second recipient state; and
associating the first receiving node with a first one of the identifiers if the first receiving node corresponds to the first recipient state; and
determining at routing logic in the electronic facsimile delivery system whether a destination identifier associated with the receiving node matches the destination data received from a first one of the transmit nodes corresponding to the first electronic facsimile, and if a match is determined and the recipient state of the first receiving node comprises the first recipient state, transmitting the first electronic facsimile to the first receiving node.

25. The method of claim 24, wherein transmitting the first electronic facsimile comprises:
routing the first electronic facsimile comprising:
determining routing requirements based on receiving node preferences, including selecting one of a group of preferences consisting of:
routing the first electronic facsimile to the first receiving node;
sending the first electronic facsimile to another destination; and
sending the first electronic facsimile to a plurality of destinations; and
routing the first electronic facsimile in accordance with the selected preference.

26. The method of claim 25, further comprising:
storing the first electronic facsimile at the electronic facsimile delivery system if the first receiving node is not available.

27. The method of claim 26, further comprising:
receiving a status notification message sent by a network element indicating the status of the first receiving node is changed from the second recipient state to the first recipient state; and
releasing the stored first electronic facsimile to the first receiving node.

28. The method of claim 1, further comprising:
storing at the electronic facsimile delivery system an online status indicator that indicates when a first one of the receiving nodes is available for communication, and an offline status indicator that indicates when a second one of the receiving nodes is not available for communication;
transmitting a first one of the electronic facsimiles via the network to the first receiving node based on the online status indicator; and
storing a second one of the electronic facsimiles corresponding to the second receiving node based on the offline status indicator.

29. The method of claim 1, further comprising:
causing a Hypertext Transfer Protocol (HTTP) connection to be established between the electronic facsimile delivery system and a first one of the receiving nodes comprising a phone; and
using the HTTP connection to obtain a recipient status of the phone as being online and available for communication, and to transmit the electronic facsimile to the phone.

30. The method of claim 11, further comprising:
causing a Hypertext Transfer Protocol (HTTP) connection to be established between the electronic facsimile delivery system and a first one of the receiving nodes comprising a phone; and
using the HTTP connection to report the recipient status of the phone as being connected to the network and available for communication, and to receive at the phone the encapsulated data for the electronic facsimile.

31. The method of claim 2, wherein establishing the communication link comprise establishing an HTTP connection.

32. The method of claim 11, wherein transmitting status notification signals comprises sending messages over the network to the electronic facsimile delivery system periodically.

33. The method of claim 1, wherein the recipient state corresponding to a first one of the receiving nodes comprises a first recipient state indicating that the first receiving node is operating in an online mode and thus available to receive a first one of the electronic facsimiles over the network.

34. A method of delivering electronic facsimiles, comprising:
providing a delivery system operable in an online mode and an offline mode, depending on states of receiving nodes to which electronic facsimiles are to be sent;
receiving one or more online/offline status signals from each of the receiving nodes;
storing status data for each of the receiving nodes in a repository of the delivery system in response to receiving the online/offline status signals;
operating the delivery system in the online mode in response to the stored status data indicating an online status for a first one of the receiving nodes, thereby transmitting a first one of the electronic facsimiles directly to the first receiving node;
operating the delivery system in the offline mode in response to the stored status data indicating an offline status for a second one of the receiving nodes, thereby storing a second one of the electronic facsimiles in the delivery system pending a change in operating modes of the delivery system with respect to the second receiving node;
wherein at least some of the receiving nodes access the delivery system via a public portion of a network.

35. The method of claim 34, further comprising:
storing the status data for the receiving nodes prior to receiving the electronic facsimiles.

36. The method of claim 34, further comprising:
receiving a first one of the status signals for the second receiving node, the first status signal indicating the status of the second receiving node has changed from offline to online;
modifying the operation mode of the delivery system with respect to the second receiving node from the offline mode to the online mode; and
sending the stored second electronic facsimile to the second receiving node.
